(19) United States
(12) Patent Application Publication
(10) Pub. No.: US 2007/0265365 A1
(43) Pub. Date: Nov. 15, 2007

(54) Water Soluble Polymers Containing Vinyl Unsaturation, Their Crosslinking and Process for Preparation Thereof

(76) Inventors: Prerana Maruti Patil, Pune (IN); Mohan Gopalkrishna Kulkarni, Pune (IN)

Correspondence Address: LADAS & PARRY, 26 WEST 61ST STREET, NEW YORK, NY, 10023, US

(21) Appl. No.: 11/665,586

(22) PCT Filed: Dec. 10, 2004
(86) PCT No.: PCT/IN04/00378

§ 371 Date: Apr. 17, 2007

(30) Foreign Application Priority Data
Oct. 29, 2004 (IN) 2138/DEL/2004

(51) Int. Cl. C08F 2/06; C08F 2/46; C08F 220/34

(52) U.S. Cl. 522/33; 522/6; 522/60; 522/65; 522/66; 526/217; 526/222; 526/262; 526/263; 526/264; 526/287; 526/303.1; 526/317.1; 526/72; 526/89

(57) ABSTRACT

This invention describes the synthesis of solvent soluble polymers using crosslinkers containing multiple unsaturations. Thus, it serves two purposes i.e. provides the functionality for further modification and also a rigidity. This selective polymerization involves copolymerization of a vinyl monomer with an inclusion complex of crosslinker either thermally/photochemically in the presence of oil/water soluble initiator in organic as well as aqueous medium. Crosslinkers used are acrylamide/methacrylamide derivatives. The inclusion complex of crosslinkers can be polymerized with the desired monomer in the first step and can be crosslinked in the second step. The content of the crosslinker can be adjusted from 0.01 to 99.99%, which gives soluble copolymers.

### FIELD OF THE INVENTIONS

This invention relates to water soluble polymers containing vinyl unsaturation, their crosslinked products and preparation thereof. More particularly, it relates to water soluble copolymers containing unsaturated sites. These polymers are obtained by the selective copolymerization of inclusion complexes of hydrophilic crosslinkers and different vinyl monomers containing only one vinyl unsaturation. They can be subsequently crosslinked in the presence of thermal/or photochemical initiators.

These copolymers have applications in the fields like immobilization of enzymes, controlled drug delivery systems, sensors, etc.

### BACKGROUND OF THE INVENTION

The present invention relates to water soluble copolymers comprising unsaturation and a process for the preparation thereof. More particularly, it relates to polymers of the formula [A(x)B(y)]ₙ, wherein A is based on any vinyl monomer comprising one unsaturation, B is based on a monomer containing multiple unsaturation and x=1 to 15, y=1 to 15, and n=5 to 1000. In our co-pending application 281NF2004, the inventors of the present invention have described the process for the preparation of inclusion complexes of cyclic macromolecular compounds with monomers containing multiple unsaturations. Polymerization of such complexes with vinyl substituted monomers yields polymers that are water soluble and have unsaturated sites for further modification.

Thermosetting polymers cannot be converted into a molten state or dissolved in solvents. Although these materials offer enhanced mechanical and thermal properties over the thermoplastics, they cannot be readily processed into finished products using processing techniques, commonly used in the case of thermoplastics. Similarly the properties of the thermoplastics cannot be significantly enhanced after converting the resins into finished products since there is no scope to modify the polymer structure chemically after the polymerization is completed.

In certain thermosetting polymers, reactive groups are introduced in the backbone. These polymers are usually in the form of lattices that are further crosslinked either thermally or by addition of functional groups like isocyanates, amines or metal ions. These resins attain their desired properties i.e., insolubility in most organic solvents, good water resistance and hardness by network formation and are used as coatings. (Van E. S. J. J in Polymeric Dispersions: Principles and Applications. Asua, J. M. (Ed), Kluwer Publishers, 1997, p. 451; Ooka, M., Ozawa, H. Progress in Organic Coatings. Vol 23, 1994, p. 325). The need for polymers which are solvent soluble and thermally fusible and which could be later converted into products having enhanced mechanical/thermal/solvent resistance properties is increasing with growing applications of polymers in different fields.

Water insoluble molecules become water soluble on treatment with aqueous solutions of cyclodextrins or similar host molecules. The inclusion phenomenon leads to significant changes in reactivity and solution properties of the guest molecule. The formation of inclusion complexes of hydrophobic monomers with β-cyclodextrin or its derivatives has been reported. (Storsberg, J., Ritter, H. Macromolecular Rapid Communications, 21, 230, 2000; Jeromin, J., Ritter, H. Macromolecular Rapid Communications, 19, 377, 1998; Jeromin, J., Noll, O., Ritter, H. Macromolecular Chemistry & Physics, 199, 2641, 1998; Glockner, P., Ritter, H. Macromolecular Rapid Communications, 20, 602, 1999). It has been established that the reactivity ratios of complexed monomers differ significantly from those of the uncomplexed monomers.

Cyclodextrins are well known cyclic oligosaccharides that can solubilize hydrophobic compounds in aqueous media (Wenz, G. Angew Chem. 106, 851, 1994). The solubilization is effected by complexation of the water insoluble species within the hydrophobic cavity of cyclodextrin. The use of cyclodextrin to dissolve suitable monomers in water has been described in the literature (Storsberg J., Ritter, H. Macromolecular Rapid Communications, 21, 236, 2000, Jeromin, J., Ritter, H. Macromolecular Rapid Communications, 19, 377, 1998, Jeromin, J., Noll, O., Ritter, H. Macromolecular Chemistry & Physics 199, 2641, 1998, Glockner, P., Ritter, H. Macromolecular Rapid Communications 20, 602, 1999). Some patents describe the use of cyclodextrin preferably in catalytic amounts in order to improve emulsion polymerization yields (U.S. Pat. No. 6,225,299 and U.S. Pat. No. 5,521,266).

The copolymerization of several N-alkyl methacrylamides with t-butyl methacrylate in water in the presence of methylated-β-cyclodextrin is described. (Ritter H., Schwarz-Barac S., Stein P., Macromolecules, 36 (2), 318-322, 2003). Methylated β-CD was used to complex the hydrophobic monomers isobornyl acrylate and butyl acrylate yielding water soluble host/guest complexes. These inclusion complexes of monomers were polymerized in water and kinetics of polymerization was investigated. It was found that reactivity ratios of complexed monomer differ significantly from uncomplexed monomers and also molecular weight of polymers obtained from complexed monomers are higher than those obtained from uncomplexed monomers. (Glockner P., Ritter H., Macromol. Rap. Comm., 20(11), 602-605, 1999). The free radical polymerization of styrene or MMA in water with potassium peroxodisulfate as free radical initiator in the presence of randomly methylated β-cyclodextrin was described. This method gives the quantitative conversion of the monomers and leads to stable latexes with nearly monodisperse polymer particle size distribution without using any surfactant (Storsberg J., van Aert H., van Roost C. & Ritter H., Macromolecules, 36, 50-53, 2003). Hydrophobic methacrylic monomers such as t-butyl methacrylate, cyclohexyl methacrylate, 2-ethyl hexyl methacrylate were complexed with methylated β-cyclodextrin. These complexes were polymerized in aqueous media using free radical initiation. (Madison P. & Long T., Biomacromolecules, 1, 615-621, 2000). Highly hydrophobic monomers cannot be readily incorporated by emulsion polymerization. The use of a catalytic level of cyclodextrin allows the use of very hydrophobic monomers in emulsion polymerization where cyclodextrin acts as a phase transport catalyst continuously complexing and solubilizing the hydrophobic monomers and releasing them to the polymer particles. (Lau W., Macromol. Symp. 182, 283-289, 2000). Free radical polymerization of complexes of N-methacryloyl-D, L-phenylalanine methyl ester derivatives focusing on enantiodiscrimination during polymerization in an aqueous medium is described. (Schwarz-Barac S., Ritter H., Schollmeyer D., Macromol. Rap. Comm., 24(4), 325-330, 2003) Emulsion polymerization of stearyl acrylate was carried out using cyclodextrin as a phase transfer agent. (Leyrer R., Machtle W., Macromol. Chem. Phy., 201, 1235-1243, 2000). The first example of the radical polymerization of a fluorinated 2-vinyl cyclopropane and its copolymerization with an alkyl 2-vinyl cyclopropane in an aqueous solution via their host-guest complexation with a randomly methylated β-cyclodextrin using a water soluble initiator 2,2′-azo bis(2-amidino propane) dihydrochloride is reported. (Choi S. W., Kretschmann O., Ritter H., Ragnoli M., Galli G., Macromol. Chem. Phys., 204, 1475-79, 2003). Methylated β-cyclodextrin was used to complex the hydrophobic monomers n-butyl acrylate, n-hexyl acrylate, and cyclohexyl acrylate yielding the corresponding water soluble host/guest complexes. (Bernhardt S., Glockner P., Ritter H., Polymer bulletin, 46, 153-157, 2001). The polymerization mechanism of methylated β-cyclodextrin complexes of phenyl methacrylate and cyclohexyl methacrylate was described by Jeromin and Ritter. (Jeromin J., Ritter H., Macromol. Rap. Comm., 19, 377-379, 1998)

A survey of the prior art in the field of polymerization of complexes containing cyclodextrin reveals that the preparation of host-guest complexes comprising monomers containing multiple unsaturation and cyclic compounds has not been reported till date. The patent application describes monomers, which contain multiple unsaturations, form inclusion complexes of varying stoichiometries with cyclodextrins. Further, the unsaturated sites encapsulated within the cyclodextrin cavity do not react with the growing free radical chain. The polymerization of inclusion complexes of vinyl monomers containing multiple unsaturation, therefore leads to soluble polymers containing unreacted unsaturated sites. Once cyclodextrin is removed from the system, the deprotected unsaturated site can participate in polymerization in the second stage and lead to crosslinked products having enhanced mechanical, thermal and solvent resistance characteristics. These polymers therefore, offer the ease of processing of thermoplastics and enhanced properties of thermosets.

In the present inventory, cyclodextrin has been used not only for the dissolution of monomers in water but it has been mainly used to encapsulate one of the unsaturation sites present in the crosslinker using physical interactions. Physical interactions are always preferred over chemical modifications as these are readily reversible. These inclusion complexes increase the solubility of the monomer and can be used for copolymerization with different monomers giving soluble polymers. The unsaturation left after polymerization can further be thermally/photochemically crosslinked to give insoluble polymers. Also, the method can be used to prepare polymers of different architectures.

The demand for environmentally benign processes is growing due to increasing awareness of environmental issues involving conventional organic solvents. The chemical industry is encouraged to look for new means to the same end for many of its traditional processes that either produce environmentally unfriendly industrial products or result in toxic by-products. In an effort to overcome such potential obstacles with minimal expense, research is directed towards the replacement of traditional organic solvents with environmentally benign compounds such as carbon dioxide, biomolecules, and water. Complexation with carbohydrate derivatives increases the solubility of hydrophobic monomers and enables its polymerization in aqueous medium. In copending application patent no. PCT/IB03/03593 cyclodextrin complexes with acrylates/methacrylates have been mentioned which have little solubility in water. Since, these complexes are hydrophobic, they are normally not suitable to synthesize water soluble polymers. Hence, there is a need to synthesize complexes comprising hydrophilic crosslinkers, which can be copolymerized with hydrophilic as well as hydrophobic monomers.

Typical water soluble crosslinkers are Methylene bis acrylamide (MBAM), Ethylene bis methacrylamide (EBMA) or Phenylene bis methacrylamide. These crosslinkers have widespread applications. MBAM improves the stability of the membrane in an oxidative environment, which shows that MBAM crosslinked styrene membrane should work well in a fuel cell environment (Becker, W.; Schmidt-Naake, G., Chemical Engg. & Technology, 25 (4) 373-377, 2002). Interpenetrating network of methacrylamide & MBAM is used for selectivity in ion sorption i.e Fe²⁺ sorption & Cr⁶⁺ rejection (Chauhan, G. S.; Mahajan, S., J. Appl. Poly. Sc., 86(31), 667-671, 2002). Superabsorbents made from Poly (Acrylamide-co-2-hydroxy ethyl methacrylate) in the presence of MBAM & potassium methacrylate are used for water managing materials for agriculture & horticulture purposes as it retains more moisture for longer time (Raju, K. M.; Raju, M. P.; Mohan, Y. M., J. Appl. Poly. Sc., 85(8), 1795-1801, 2002). Poly (2-acrylamido methyl propane sulphonic acid) prepared in the presence of MBAM & benzophenone was found suitable for molecularly imprinted membrane synthesis (Piletsky, S. A.; Matuschewski, H.; Schedler, U.; Wilpert, A.; Piletska, E. V.; Thiele, T. A.; Ulbricht, Macromolecules, 33(8), 3092-98, 2000). Also, thermally stable water swollen gels are used for fluid diversion in petroleum production (Suda, Makoto; Kurata, Tooru; Fukai, Toshihiro; Maeda, Kenichiro, J. Pet. Sci Eng., 26 (1-4), 1-10, 2000). When Polyacrylamide gels we8re prepared in the presence of MBAM, Ethylene glycol dimethacrylate, 1,4 butanediol diacrylate/diallyl phthalate, water absorbency was enhanced when MBAM was used as a crosslinking agent (Raju, K. Mohana; Raju, M. Padmanabha; Mohan, Y. Murali, Polymer International, 52(5), 768-72, 2003).

Water-soluble monomers such as acrylamide, acrylic acid or N-vinyl pyrrolidone are normally used in the presence of crosslinkers for immobilization of enzymes and in many other fields. Poly (acrylic acid) prepared in the presence of a MBAM, benzyldimethyl ketal pyrrolidone carboxylic acid is used as bioelectrodes with low impedance between electrode & skin (JP 09038057 and JP 09038057). Poly (acrylamide-co-N acryloyl para amino benzamidine) synthesized in the presence of MBAM is used as molecularly imprinted polymeric receptor for trypsin (Vaidya A. A.; Lele, B. S.; Kulkarni, M. G.; Mashelkar, R. A. J. App. Poly. Sc., 81(5), 1075-83, 2001).

Poly (N-isopropyl acrylamide-co-MBAM) can be used for the concentration of either nucleic acids/proteins (Pichot, C.; Elaisari, A.; Duracher, D.; Meunier, F.; Sauzedde, F. Macromol. Symposia, 175, 285-397, 2001). Poly (N-isopropyl acrylamide-co-acrylic acid) hydrogel prepared in the presence of MBAM is used for concentrating aqueous dispersions of bacteria (Champ, S.; Xue, W.; Huglin, M. B. Macromol. Chem. & Phys., 201(17), 2505-2509, 2000). Poly (Acrylamide-co-Na acrylate) synthesized in the presence of MBAM was found to be useful for immobilization of Saccharomyces cerevisiae enzyme. (Oztop, H. N.; Oztop, A. Y.; Karadag, E.; Jsikver, Y.; Saraydin, D., Enzyme & Microbial Technology, 32(1), 114-119, 2003). Poly (N-isopropyl acrylamideco-2-hydroxy ethyl methacrylate) prepared in the presence of MBAM is used in enzyme activity control, extraction & drug delivery systems (Lee, W. F.; Huang, Y. L. J. App. Poly. Sc., 77(8), 1769-1781, 2000). However, in all these cases, the unreacted crosslinker, which is toxic, is difficult to remove from these swollen gels. (George D. J., Price J. C., Marr C. M., Myers B. C., Schwetz A. B. and Heindel J. J. Toxicological science 46(1), 1998, 124-133). Hence, if a polymer comprising MBAM, free from unreacted MBAM will overcome one of the limitations of these polymers in intended applications. It is the objective of this invention to demonstrate synthesis of such copolymers. In the copending application 281NF2004, the inventors of the present invention have described the preparation of inclusion complexes of cyclodextrins with monomers containing multiple unsaturations. Polymerization of these complexes gives rise to soluble homopolymers containing unsaturated sites, which can be further crosslinked. But applications of homopolymers of monomers having multiple unsaturations are limited. Copolymerization of different monomers with the crosslinker gives rise to tailor made materials for a wide range of applications. Depending upon the composition of the comonomers either hydrophilic, hydrophobic or amphiphilic polymers can be synthesized. If unsaturated groups are incorporated into these copolymers, they can be crosslinked in a second step. Such polymers would find applications in immobilization of enzymes, electronics, photoresists, controlled release delivery systems, micro electro mechanical systems (MEMS) etc.

### OBJECT OF THE INVENTION

The object of the present invention is therefore to provide water-soluble copolymers of vinyl monomers containing multiple unsaturations, crosslinking by thermal/photochemical route and process for the preparation of the polymers containing multiple unsaturation as well as for the crosslinked products

### SUMMARY OF THE INVENTION

This invention describes hydrophilic copolymers comprising multiple unsaturations, which are obtained by polymerization of inclusion complex of monomers containing multiple vinyl unsaturations and different hydrophilic monomers. The hydrophilic comonomers, which can be used in the synthesis of such polymers, are typically acrylic acid, N-vinyl pyrrolidone, 2-hydroxy ethyl methacrylate, 4-vinyl pyridine, dimethyl amino ethyl methacrylate, hydroxypropyl methacrylamide, acrylamide, etc. The monomers containing multiple vinyl unsaturations, which can be used in the synthesis of these polymers, are exemplified by methylene bis acrylamide (MBAM), ethylene bis methacrylamide (EBMA). The copolymerization can be carried out in aqueous media rather than in organic polar solvents like dimethyl formamide and/or dimethyl sulphoxide as described in the previous application PCT/IB03/05070. Further, the crosslinkers are more hydrophilic and are essentially water soluble. Thus, the present invention describes a method of preparing copolymers of inclusion complexes of crosslinkers and hydrophilic vinyl monomers. These copolymers are water soluble and contain unsaturation since only one of the two or more unsaturation sites present in the crosslinker takes part in the polymerization reaction. These copolymers are readily soluble in hydrophilic solvents such as methanol, N,N′ dimethyl formamide, dimethyl sulphoxide and especially water. The copolymerization can be carried out in organic solvents like N,N′ dimethyl formamide, dimethyl sulphoxide or aqueous media using either oil or water soluble initiator. These copolymers can be further crosslinked using thermal and/or photochemical initiators either in organic/aqueous media.

### DETAILED DESCRIPTION OF THE INVENTION

Accordingly, the present invention provides water-soluble copolymers of vinyl monomers containing multiple unsaturations having a general formula [A₍ₓ₎B_{(y)}]ₙ, wherein A is based on any vinyl monomer comprising one unsaturation, B is based on a monomer containing multiple unsaturation and x=1 to 15, y=1 to 15 and n=10 to 1000.

The present invention also provides a process for the preparation of water soluble copolymers which comprises dissolving an inclusion complex of the monomer containing multiple unsaturation with a cyclic macromolecular compound in an appropriate solvent, adding at least one vinyl monomer and a free radical initiator to this solution and polymerizing the mixture by conventional methods like redox, thermal or photopolymerization.

In one of the embodiments of the present invention the inclusion complexes may be prepared as per the process claimed and described in our co-pending application 281 NF2004.

In another embodiment the content of the inclusion complex containing multiple unsaturation may be varied from 0.01 to 99.9%.

In yet another embodiment, the monomer containing multiple unsaturation may be from the group of bis acrylamides/methacrylamides.

In another embodiment the inclusion complex may be a monomer containing multiple unsaturation such as bis or tris acrylamides or methacrylamides as exemplified by Ethylene bis acrylamide/Ethylene bis methacrylamide, Methylene bis acrylamide/Methylene bis methacrylamide, Propylene bis acrylamide/Propylene bis methacrylamide, Butylene bis acrylamide/Butylene bis methacrylamide, Phenylene bis acrylamide/Phenylene bis methacrylamide, Tris (2-methacrylamido ethyl)amine/Tris (2-acrylamido ethyl)amine, 2,4,6-Tris methacrylamido-1,3,5-triazine/2,4,6-Tris acrylamido-1,3,5-triazine, N,N′-(4,7,10-tris oxa tridecamethylene)-bis acrylamide/N,N′-(4,7,10-tris oxa tridecamethylene)-bis methacrylamide, N,N′-(4,9-dioxa dodecamethylene)-bis acrylamide/N,N′-(4,9-dioxa dodecamethylene)-bis methacrylamide, 2,4,5,6 tetra-methacrylamido pyrimidine sulfate/2,4,5,6 tetra-acrylamido pyrimidine sulfate, 4,5,6 tris acrylamido pyrimidine sulfate/4,5,6 tris methacrylamido pyrimidine sulfate.

In still another embodiment, the vinyl monomer comprising one unsaturation may be hydrophobic or hydrophilic.

In still another embodiment, the hydrophilic vinyl monomer comprising one unsaturation may be acidic, basic or neutral.

In still another embodiment, acidic hydrophilic vinyl monomer comprising one unsaturation may be acrylic acid, methacrylic acid, acrylamido methyl propane sulphonic acid, etc.

In still another embodiment, basic hydrophilic vinyl monomer may be 2-dimethyl amino ethyl methacrylate, 4-vinyl pyridine.

In still another embodiment, neutral hydrophilic vinyl monomer may be N-vinyl pyrrolidone, 2-hydroxylpropyl methacrylamide, 2-amino ethyl acrylate hydrochloride, N-isopropyl acrylamide, acrylamide, t-butyl acrylamide, etc.

In yet another embodiment the solvent for preparing solution of inclusion complex may be chosen from polar solvents exemplified by N,N′ dimethyl formamide, N,N′ dimethyl acetamide, dimethyl sulphoxide, chloroform and water.

In yet another feature, the conventional method used for the preparation of copolymers may be thermal, redox or photopolymerization.

In yet another embodiment, the thermal/redox initiators used for polymerization may be oil or water soluble.

In yet another embodiment, the oil soluble thermal initiators may be azo bis isobutyronitrile, benzoyl peroxide, t-butyl hydroperoxide, cumyl peroxide.

In yet another embodiment, the water-soluble thermal or redox initiators may be potassium persulfate, ammonium persulfate or sodium metabisulphite-potassium persulphate.

In yet another embodiment, photoinitiators used for copolymerization may be oil or water soluble.

In yet another embodiment, water-soluble photoinitiator used may be 2,2′ azo bis(2-amidino propane) dihydrochloride.

In yet another embodiment, oil soluble photoinitiator used may be 1-hydroxy cyclohexyl phenyl ketone, 2,2′-azobis (2,4-dimethyl valeronitrile), 2,2′-azobis (2,4-methyl butyronitrile), 2,2 dimethoxy-2-phenyl acetophenone.

In yet another embodiment, the reaction temperature for copolymerization may be from 20° C. to 65° C.

In yet another embodiment, the copolymers are soluble in organic solvents as well as in water and contain unsaturated groups.

In yet another embodiment, the soluble copolymers prepared may be crosslinked using conventional free radical polymerization methods to give insoluble polymers.

In yet another embodiment, the solvent for preparing solution of copolymer to carry out crosslinking may be chosen from polar solvents exemplified by N,N′ dimethyl formamide, N,N′ dimethyl acetamide, dimethyl sulfoxide, chloroform and water.

In yet another embodiment, the copolymers can be crosslinked in the presence of thermal/photochemical initiators.

In yet another embodiment, the thermal/redox initiators used for crosslinking may be oil or water-soluble.

In yet another embodiment, the oil soluble thermal initiators used for crosslinking may be azo bis isobutyronitrile, benzoyl peroxide, t-butyl hydroperoxide.

In yet another embodiment, the water-soluble thermal or redox initiators used for crosslinking may be potassium persulfate, ammonium persulfate or potassium persulphate-sodium metabisulphite.

In yet another embodiment, photoinitiators used for crosslinking may be oil/water soluble.

In yet another embodiment, water-soluble photoinitiator used for crosslinking may be 2,2′ azo bis(2-amidino propane) dihydrochloride.

In yet another embodiment, oil soluble photoinitiator used for crosslinking may be 1-hydroxy cyclohexyl ketone, cumene hydroperoxide, 2,2 dimethoxy-2-phenyl acetophenone.

In yet another embodiment, the reaction temperature for crosslinking may be from 20° to 65° C.

Natural polymers such as cellulose, proteins, chitosan, guar gum and synthetic polymers such as polyvinyl alcohol are crosslinked using glutaraldehyde. But, the presence of unreacted crosslinker in the network of gels restricts their application since they are toxic. Hence, there is a need to remove these unreacted crosslinkers from the network of gel in an independent step. Polymers prepared in the presence of cross linkers such as MBAM form gels and are useful in immobilization of enzymes and drug delivery systems but suffer from the same limitation. This problem can be over come if a crosslinker can be made a part of the polymer maintaining the polymer still in a soluble state, the unreacted crosslinker, monomer be completely removed by washing and then the cross linking is brought about after the encapsulation of the active ingredient, especially a labile one such as an enzyme. We have overcome this limitation, by synthesizing these gels in two steps. In the first step, only one unsaturated site of crosslinker takes part in polymerization and gives solvent soluble polymers with pendent unsaturation. The unreacted crosslinker can be removed at this stage and the polymer contains no free crosslinker, which can be crosslinked to get insoluble gel. Furthermore, the pendent unsaturation can be used to design different polymer architectures.

To protect the second vinyl group of divinyl monomer during the first polymerization step, the divinyl monomer is complexed with cyclodextrin. We report the use of cyclodextrin to form an inclusion complex with the divinyl monomer which prevents the polymerization of the vinyl group incorporated in the cyclodextrin cavity. After the polymerization in the first step, the unsaturated site can be deprotected by removing cyclodextrin. The deprotected vinyl group can now be used for crosslinking process or for copolymerization with different monomers in second step. Upto now, cyclodextrin has been used for dissolution of the hydrophobic monomers or as surfactant in emulsion polymerizations.

Here, the inclusion complex of the monomer is copolymerized with vinyl monomer. This copolymerization gives the solvent soluble copolymers with pendent vinyl unsaturation whereas the conventional polymerization of the crosslinkers does not. The pendent unsaturation can be further used for crosslinking or to design different architectures of polymers.

Cyclodextrin host—guest complexes of monomers having multiple unsaturations used in the present invention have not been reported till date. The copolymers mentioned in this invention are synthesized from cyclodextrin host-guest complexes. This has been now explained more clearly in the text in the examples 1, 3-12, 14-17.

### EXAMPLES

The invention is now described below by examples, which are illustrative but do not limit the scope of the invention. The NMR data given below in the examples indicates the presence of unsaturation in the copolymers synthesized.

### Example 1

This example describes the preparation of Poly (N-Vinyl pyrrolidone-co-Ethylene bis methacrylamide NVP:EBMA 90:10).

1.331 g (0.001 moles) β-cyclodextrin-Ethylene bis methacrylamide complex, 1 g NVP (0.009 moles) were dissolved in 33.3 ml water. To this 32.8 mg potassium persulphate was added and the tube was purged with nitrogen and dipped in a water bath maintained at 65° C. for 24 hours. The resultant solution was concentrated at room temperature and then dissolved in methanol so that polymer dissolves in methanol and β-cyclodextrin could be separated by filtration. The filtrate obtained was precipitated in petroleum ether. It was dried in a desiccator at room temperature. The yield was 86%. The polymer was found to be soluble in methanol, water, N,N′ dimethyl formamide & dimethyl sulphoxide. The polymer was characterized by ¹H NMR and IR spectroscopy. Both methods showed the presence of unsaturation even after polymerization while IR analysis shows the presence of amide functionality. The presence of unsaturation in polymer & its solubility in common solvents even after polymerization indicates the selective polymerization of only one vinyl group in the crosslinker with NVP.

¹H NMR (D₂O): 3.44 δ, CH₂, 5.44, 5.65 δ, 2H, ═CH₂, 1.95 δ, CH₃ of EBMA, 2.1-2.2 δ, 2.5δ, 3.5δ CH₂ of NVP & 0.85, 1.38δ —CH₂—CH.

IR (nujol): 1656 cm⁻¹, C═O, 1616 cm⁻¹ —C═C—, 2852, 2926 cm⁻¹ —CH₃, 1458 cm⁻¹ ═CH₂ of EBMA 1710 cm⁻¹ C═O of NVP.

Intrinsic Viscosity: [η]=0.17 dl/g

### Comparative Example 2

1 g N-vinyl pyrrolidone (0.009 moles), 0.1960 g Ethylene bis methacrylamide (0.001 moles) and 1.1350 g (0.001 moles) β-cyclodextrin were dissolved in 33.3 ml water. 32.8 mg potassium persulphate was added and the tube was purged with nitrogen for 10 min. The polymerization was carried out at 65° C. for 20 min. The polymer was obtained in the form of an insoluble gel.

From the above two experiments, it was confirmed that EBMA forms inclusion complex with cyclodextrin & the unsaturation involved in the formation of the inclusion complex does not take part in the polymerization reaction.

### Example 3

This example describes the preparation of Poly (Dimethyl amino ethyl methacrylate-co-Ethylene bis methacrylamide DMAEMA:EBMA 90:10).

1.413 g dimethyl amino ethyl methacrylate (0.009 moles), 1.331 g (0.001 moles) β-cyclodextrin-Ethylene bis methacrylamide complex were dissolved in 16.25 ml N,N′ dimethyl formamide (DMF). 32.8 mg azo bis isobutyronitrile was added and the test tube was purged with nitrogen for 10 min. The polymerization was carried out at 65° C. for 24 hours. The resultant solution was concentrated at room temperature & then dissolved in methanol so that polymer dissolves in methanol and β-cyclodextrin could be separated by filtration. The filtrate obtained was precipitated in petroleum ether. The polymer yield was 50%. The polymer was soluble in methanol, water, N,N′ dimethyl formamide and dimethyl sulphoxide. The polymer was characterized by ¹H NMR and IR spectroscopy.

¹H NMR (D₂O): 3.44 δ, CH₂, 5.44, 5.65 δ, 2H, ═CH₂, 1.95 δ, CH₃ of EBMA, 2.3, 2.65, 4.3δ of DMAEMA, 0.82, 0.92 δ—CH—CH₂.

IR (nujol): 1656 cm⁻¹, C═O, 1616 cm⁻¹ —C═C—, 1458 cm⁻¹ ═CH₂ of EBMA, 1720 cm⁻¹ C═O of DMAEMA, 2852, 2926 cm⁻¹ —CH₃.

### Example 4

This example describes the preparation of Poly (2-hydroxyethyl methacrylate-co-Ethylene bis methacrylamide (HEMA:EBMA 90:10).

1.1713 g (0.009 moles) 2-hydroxyethyl methacrylate, 1.331 g (0.001 moles) β-cyclodextrin-Ethylene bis methacrylamide complex were dissolved in 14.8 ml DMF. To this 32.8 mg azo bis isobutyronitrile was added and the test tube was purged with nitrogen for 10 minutes. Polymerization was carried out at 65° C. for 24 hours. The resultant solution was concentrated at room temperature and then dissolved in methanol so that polymer dissolves in methanol and β-cyclodextrin could be separated by filtration. The filtrate obtained was precipitated in petroleum ether. The yield obtained was 65%. The polymer was soluble in methanol, water, N,N′ dimethyl formamide, dimethyl sulphoxide. The polymer was characterized by ¹H NMR and IR spectroscopy.

¹H NMR (D₂O): 3.44 δ, —OCH₂, 5.44, 5.65 δ, ═CH₂, 1.95 δ, —CH₃ of EBMA, 3.8 δ, 4.5 δ & 1.95 δ of HEMA, 0.82, 0.92 δ —CH—CH₂.

IR (nujol): 1656 cm⁻¹, C═O, 1616 cm⁻¹, C═C, 1435 cm⁻¹ ═CH₂ of EBMA, 1720 cm⁻¹ C═O, 3450 cm⁻¹ OH of HEMA, 2854, 2926 cm⁻¹ CH₃.

Intrinsic Viscosity: [η]=0.1 dl/g

### Example 5

This example describes the preparation of Poly (N-3 hydroxypropyl methacrylamide-co-Ethylene bis methacrylamide (N-3 HPMA:EBMA 90:10).

1.2870 g (0.009 moles) N-3 hydroxypropyl methacrylamide, 1.331 g (0.001 moles) β-cyclodextrin-Ethylene bis methacrylamide complex were dissolved in 15.5 ml DMF. To this, 32.8 mg azo bis isobutyronitrile was added. Nitrogen gas was purged through the reaction mixture for about 10 min and the polymerization was carried out at 65° C. for 24 hours. The resultant solution was concentrated at room temperature and then dissolved in methanol so that polymer dissolves in methanol and β-cyclodextrin could be separated by filtration. The filtrate obtained was precipitated in petroleum ether. The yield was 64%. The polymer was soluble in methanol, water, N,N′ dimethyl formamide, dimethyl sulphoxide. The polymer was characterized by ¹H NMR and IR spectroscopy.

¹H NMR (D₂O): 5.44 δ, 5.66 δ ═CH₂, 3.44 δ, —CH₂, 1.95 δ of EBMA, 1.88 δ, 3.28 δ, 3.6 δ of N-3 HPMA.

IR (nujol): 1656 cm⁻¹, C═O, 1616 cm⁻¹, C═C, of EBMA, 3300-3500 OH of N-3 HPMA, 2856, 2924 cm⁻¹ —CH₃.

Intrinsic Viscosity: [η]=0.05 dl/g

### Example 6

This example describes the preparation of Poly (Acrylic acid-co-Ethylene bis methacrylamide M:EBMA 90:10).

0.6480 g (0.009 mole) Acrylic acid, 1.331 g (0.001 mole) β-cyclodextrin-Ethylene bis methacrylamide complex were dissolved in 11.7 ml DMF. To this 32.8 mg azo bis isobutyronitrile was added. Nitrogen gas was purged through the reaction mixture for about 10 min. and the polymerization was carried out at 65° C. for 24 hours. The resultant solution was concentrated at room temperature and then dissolved in methanol so that polymer dissolves in methanol and β-cyclodextrin could be separated by filtration. The obtained filtrate was precipitated in petroleum ether. The yield was 67%. The polymer was soluble in methanol, water, N,N′ dimethyl formamide, dimethyl sulphoxide. The polymer was characterized by ¹H NMR and IR spectroscopy.

¹H NMR (D₂O): 5.44 δ, 5.66 δ ═CH₂, 3.44 δ, —CH₂, 1.95 δ CH₃ of EBMA.

IR (nujol): 1656 cm⁻¹, C═O, 1616 cm⁻¹, C═C of EBMA, 2900-3200 OH of M, 2856, 2924 cm⁻¹ —CH₃.

### Example 7

This example describes the preparation of Poly (Methyl methacrylate-co-Ethylene bis methacrylamide MMA:EBMA 80:20).

1 g (0.01 mole) methyl methacrylate, 3.3275 g (0.0025 mole) β-cyclodextrin-Ethylene bis methacrylamide complex were dissolved in 25.6 ml DMF. To this 41 mg azo bis isobutyronitrile was added. Nitrogen gas was purged through the reaction mixture for about 10 min. and the polymerization was carried out at 65° C. for 24 hours. The resultant solution was precipitated in water so that polymer precipitates and cyclodextrin dissolves in water. The precipitated polymer was filtered & dried. The yield was 72%. The polymer was soluble in chloroform, tetrahydrofuran, N,N′ dimethyl formamide, dimethyl sulphoxide. The polymer was characterized by ¹H NMR and IR spectroscopy.

¹H NMR (CHCl₃): 5.44 δ, 5.66 δ ═CH₂, 3.44 δ, —CH₂, 1.95 δ of EBMA, 3.6δ —OCH₃ of MMA.

IR (nujol): 1656 cm⁻¹, C═O, 1616 cm⁻¹, C═C of EBMA, 1728 cm⁻¹, C═O of MMA, 2856, 2924 cm⁻¹ —CH₃.

### Example 8

This example describes the preparation of Poly (4-Vinyl pyridine-co-Ethylene bis methacrylamide 4-VP:EBMA 90:10).

0.9462 g (0.009 mole) 4-Vinyl pyridine, 1.331 g (0.001 mole) β-cyclodextrin-Ethylene bis methacrylamide complex were dissolved in 13.5 ml DMF. To this 32.8 mg azo bis isobutyronitrile was added. Nitrogen gas was purged through the reaction mixture for about 10 min. and the polymerization was carried out at 65° C. for 24 hours. The resultant solution was concentrated at room temperature and then the solid obtained was dissolved in methanol so that polymer dissolves in it and cyclodextrin is precipitated. The polymer solution was then precipitated in petroleum ether. The yield was 58%. The polymer was soluble in methanol, water, N,N′ dimethyl formamide, dimethyl sulphoxide. The polymer was characterized by ¹H NMR and IR spectroscopy.

¹H NMR (D₂O): 5.44 δ, 5.66δ ═CH₂, 3.44 δ, —CH₂, 1.95 δ of EBMA, 8.33 δ, 6.6 δ, 7.2 δ CH₂ of 4-Vinyl pyridine.

IR (nujol): 1656 cm⁻¹, C═O, 1616 cm⁻¹, C═C of EBMA, 3300-3400 cm⁻¹, 1600 cm⁻¹, 1500 cm⁻¹ of 4-VP, 2856, 2924 cm⁻¹ —CH₃.

Intrinsic Viscosity: [η]=0.06 dl/g

### Example 9

This example describes the preparation of Poly (N-vinyl pyrrolidone-co-Methylene bis acrylamide NVP:MBAM 85:15).

1 g (0.009 mole) N-vinyl pyrrolidone, 2.0465 g (0.0016 mole) β-cyclodextrin-methylene bis acrylamide complex were dissolved in 18 ml DMF. To this, 34.7 mg azo bis isobutyronitrile was added. Nitrogen gas was purged through the reaction mixture for about 10 min. and the polymerization was carried out at 65° C. for 24 hours. The resultant solution was concentrated at room temperature and then the solid obtained was dissolved in methanol so that polymer dissolves and cyclodextrin is precipitated. The polymer solution was then precipitated in petroleum ether. The yield was 74%. The polymer was soluble in methanol, water, N,N′ dimethyl formamide, dimethyl sulphoxide. The polymer was characterized by ¹H NMR and IR spectroscopy.

¹H NMR (D₂O): 5.44 δ, 5.66δ ═CH₂, 4.5 δ, —CH₂ of MBAM, 2.1 δ, 2.5 δ, 3.5 δ CH₂ of NVP.

IR (nujol): 1660 cm⁻¹, C═O, 1620 cm⁻¹, C═C of MBAM, 1710 cm⁻¹ of NVP.

### Example 10

This example describes the preparation of Poly (Dimethyl amino ethyl methacrylate-co-Methylene bis acrylamide DMAEMA:MBAM 85:15).

1 g (0.0064 mole) Dimethyl amino ethyl methacrylate, 1.45 g (0.0011 mole) β-cyclodextrin-Methylene bis acrylamide complex were dissolved in 14.5 ml DMF. To this 24.5 mg azo bis isobutyronitrile was added. Nitrogen gas was purged through the reaction mixture for 10 min. and the polymerization was carried out at 65° C. for 24 hours. The resultant solution was concentrated at room temperature and then the solid obtained was dissolved in methanol so that polymer dissolves in it and cyclodextrin is precipitated. The polymer solution was then precipitated in petroleum ether. The yield was 69%. The polymer was soluble in methanol, water, N,N′ dimethyl formamide, dimethyl sulphoxide. The polymer was characterized by ¹H NMR and IR spectroscopy.

¹H NMR (D₂O): 5.44 δ, 5.66 δ ═CH₂, 4.5 δ, —CH₂ of MBAM, 2.3 δ, 2.6 δ, 4.3 δ of DMAEMA.

IR (nujol): 1660 cm⁻¹, C═O, 1620 cm⁻¹, C═C of MBAM, 1730 cm⁻¹ C═O of DMAEMA, 2856, 2924 cm⁻¹ —CH₃.

Intrinsic Viscosity: [η]=0.2 dl/g

### Example 11

This example describes the preparation of Poly (2-hydroxy ethyl methacrylate-co-Methylene bis acrylamide HEMA:MBAM 85:15).

1.1062 g (0.0085 mole) 2-hydroxy ethyl methacrylate, 1.9535 g (0.0015 mole) β-cyclodextrin-Methylene bis acrylamide complex were dissolved in 18 ml DMF. To this, 32.8 mg azo bis isobutyronitrile was added. Nitrogen gas was purged through the reaction mixture for 10 min. and the polymerization was carried out at 65° C. for 24 hours. The resultant solution was concentrated at room temperature & then the solid obtained was dissolved in methanol so that polymer dissolves in it and cyclodextrin is precipitated. The polymer solution is then precipitated in petroleum ether. The yield was 74%. The polymer was soluble in methanol, water, N,N′ dimethyl formamide, dimethyl sulphoxide. The polymer was characterized by ¹H NMR and IR spectroscopy.

¹H NMR (D₂O): 5.44 δ, 5.66δ ═CH₂, 4.5 δ, —CH₂, 1.95 δCH₃ of MBAM.

IR (nujol): 1660 cm⁻¹, C═O, 1620 cm⁻¹, C═C of MBAM, 1730 cm⁻¹ C═O, 3300-3500 cm⁻¹ —OH of HEMA, 2856, 2924 cm⁻¹ —CH₃.

### Example 12

This example describes the preparation of Poly (Methyl methacrylate-co-Methylene bis acrylamide (MMA:MBAM 80:20).

0.8 g (0.008 mole) Methyl methacrylate, 2.578 g (0.002 mole) β-cyclodextrin-Methylene bis acrylamide complex were dissolved in 21.2 ml DMF. To this 32.8 mg azo bis isobutyronitrile was added. Nitrogen gas was purged through the reaction mixture for about 10 min. and the polymerization was carried out at 65° C. for 24 hours. The resultant solution was precipitated in water so that polymer precipitates and cyclodextrin is dissolved in water. The precipitated polymer was filtered and dried. The yield was 78%. The polymer was soluble in methanol, water, N,N′ dimethyl formamide, dimethyl sulphoxide. The polymer was characterized by ¹H NMR and IR spectroscopy.

¹H NMR (CDCl₃): 5.44 δ, 5.66δ ═CH₂, 4.5 δ, —CH₂ of MBAM, 3.6δ OCH₃ of MMA.

IR (nujol): 1660 cm⁻¹, C═O, 1620 cm⁻¹, C═C of MBAM, 1728 cm⁻¹, C═O of MMA, 2856, 2924 cm⁻¹ —CH₃.

### Example 13

This example describes the preparation of Poly (N-Vinyl pyrrolidone-co-Ethylene bis methacrylamide NVP:EBMA 90:10) by photopolymerization.

1 g N-vinyl pyrrolidone (0.009 moles) and 1.331 g (0.001 moles) β-cyclodextrin-Ethylene bis methacrylamide complex were dissolved in 2 ml dimethyl formamide. To this, 5 mg 1-hydroxy cyclohexyl phenyl ketone was added and the solution was exposed to UV irradiation at room temperature for 20 min. The polymer was obtained by dissolving in methanol & then precipitating in petroleum ether. The yield was 87%. The polymer was soluble in methanol, water, N,N′ dimethyl formamide, dimethyl sulphoxide. The polymer was characterized by ¹H NMR and IR spectroscopy.

¹H NMR (D₂O): 3.44 δ, CH₂, 5.44, 5.65 δ, ═CH₂, 1.95 δ CH₃ of EBMA, 2.1-2.2 δ, 2.5δ, 3.5δ CH₂ of NVP, 0.85, 1.03 δ —CH₂—CH.

IR: 1656 cm⁻¹, C═O, 1616 cm⁻¹ —C═C—, of EBMA, 1458 cm⁻¹ ═CH₂, 2852, 2926 cm⁻¹ —CH₃.

### Example 14

This example describes the preparation of Poly (N-Vinyl pyrrolidone-co-Ethylene bis methacrylamide (EBMA) 40:60).

7.9839 g (0.006 moles) β-cyclodextrin-ethylene bis methacrylamide complex, 1 g N-Vinyl pyrrolidone (0.009 moles) were dissolved in 39.9 ml N,N dimethyl formamide. To this 36.9 mg azo bis isobutyronitrile was added and the tube was purged with nitrogen and dipped in a water bath maintained at 65° C. for 24 hours. The resultant solution was concentrated at room temperature and then dissolved in methanol so that polymer dissolves in methanol and β-cyclodextrin remains undissolved which was separated by filtration. The filtrate obtained was precipitated in petroleum ether. It was dried in a desiccator at room temperature. The yield was 88%. The polymer was soluble in methanol, water, N,N′ dimethyl formamide, dimethyl sulphoxide. The polymer was characterized by ¹H NMR and IR spectroscopy. Both the methods showed the presence of unsaturation while IR shows the presence of amide functionality.

¹H NMR (D₂O): 3.44 δ, CH₂, 5.44, 5.65 δ, 2H, ═CH₂ of EBMA, 2.1-2.2 δ, 2.5δ, 3.5δ CH₂ of NVP, 1.95 δ, s-CH₃, 0.85, 1.03 δ —CH2-CH.

IR: 1656 cm⁻¹, C═O, 1616 cm⁻¹ —C═C—, 2852, 2926 cm⁻¹ —CH₃, 1458 cm⁻¹ ═CH₂ of EBMA, 1710 cm⁻¹ C═O of NVP.

### Example 15

This example describes the preparation of Poly (N-Vinyl pyrrolidone-co-Ethylene bis methacrylamide NVP:EBMA 85:15).

1.9965 g (0.0015 moles) β-cyclodextrin-Ethylene bis methacrylamide complex, 0.9447 g N-Vinyl pyrrolidone (0.0085 moles) were dissolved in 17.4 ml N,N dimethyl formamide. To this, 32.8 mg azo bis isobutyronitrile was added and the tube was purged with nitrogen and dipped in a water bath maintained at 65° C. for 24 hours. The resultant solution was concentrated at room temperature and then dissolved in methanol so that polymer dissolves in methanol and β-cyclodextrin, which could be separated by filtration. The filtrate obtained was precipitated in petroleum ether. It was dried in a desiccator at room temperature. The yield was 68%. The polymer was soluble in methanol, water, N,N′ dimethyl formamide, dimethyl sulphoxide. The polymer was characterized by ¹H NMR and IR spectroscopy. Both methods showed the presence of unsaturation while IR shows the presence of amide functionality.

¹H NMR (D₂O): 3.44 δ, CH₂, 5.44, 5.65 δ, 2H, ═CH₂ of EBMA, 2.1-2.2 δ, 2.5δ, 3.5δ CH₂ of NVP, 1.95 δ, —CH₃, 0.85, 1.03 δ —CH₂—CH.

IR: 1656 cm⁻¹, C═O, 1616 cm⁻¹ —C═C—, 2852, 2926 cm⁻¹ —CH₃, 1458 cm⁻¹ ═CH₂ of EBMA, 1710 cm⁻¹ C═O of NVP.

### Example 16

This example describes the preparation of Poly (4-Vinyl pyridine-co-Methylene bis acrylamide 4-VP:MBAM 90:10).

0.4732 g (0.0045 mole) neutralized 4-Vinyl pyridine using HCl, 0.7427 g (0.005 mole) methylated cyclodextrin-Methylene bis acrylamide complex were dissolved in 22 ml water. To this, 27 mg potassium persulphate was added. Nitrogen gas was purged through the reaction mixture for about 10 min. and the polymerization was carried out at 65° C. for 24 hours. The resultant solution was poured in acetone so that polymer was precipitated and methylated cyclodextrin remains soluble. The yield was 69%. The polymer was soluble in methanol, water, N,N′ dimethyl formamide, dimethyl sulphoxide. The polymer was characterized by ¹H NMR and IR spectroscopy.

¹H NMR (D₂O): 5.44 δ, 5.66δ ═CH₂, 3.44 δ, —CH₂, 1.95 δ of EBMA, 8.33 δ, 6.6 δ, 7.2 δ CH₂ of 4-VP.

IR (nujol): 1656 cm⁻¹, C═O, 1616 cm⁻¹, C═C of EBMA, 3300-3400 cm⁻¹, 1600 cm⁻¹, 1500 cm⁻¹ of 4-VP, 2856, 2924 cm⁻¹ —CH₃.

### Example 17

This example describes the preparation of Poly (Acrylamide-co-Methylene bis acrylamide AM:MBAM 90:10).

1 g (0.0141 mole) Acrylamide, 2.3245 g (0.0016 mole) methylated cyclodextrin-Methylene bis acrylamide complex were dissolved in 100 ml water. To this, 84.61 mg potassium persulphate was added. Nitrogen gas was purged through the reaction mixture for 10 min. and the polymerization was carried out at 65° C. for 24 hours. The resultant solution was poured in acetone so that polymer gets precipitated and methylated cyclodextrin remained soluble. The yield was 96%. The polymer was soluble in water, N,N′ dimethyl formamide, dimethyl sulphoxide. The polymer was characterized by ¹H NMR and IR spectroscopy.

¹H NMR (D₂O): 5.44 δ, 5.66δ ═CH₂, 3.44 δ, —CH₂, 1.95 δ of EBMA

IR (nujol): 1656 cm⁻¹, C═O, 1616 cm⁻¹, C═C of EBMA, 3100 cm⁻¹, 1640 cm⁻¹ of AM.

Intrinsic Viscosity: [η]=1.85 dl/g

### Example 18

This example describes the photocrosslinking of Poly (Acrylamide-co-Methylene bis acrylamide AM:MBAM 90:10).

0.1 g Poly (Acrylamide-co-Methylene bis acrylamide) prepared according to example 17, was dissolved in 4 ml water and 10 mg photo initiator 2,2′-azobis (2-amidinopropane) dihydrochloride was added. The solution was exposed to UV irradiation for 15 min. The polymer was crosslinked and formed a gel. This is an indirect evidence for the selective polymerization of one vinyl group in the first stage followed by a second stage polymerization leading to crosslinking. The polymer after crosslinking was found to be insoluble in water, DMF, methanol & DMSO. The polymer obtained shows swelling in water almost 15 times.

### Example 19

This example describes the photocrosslinking of Poly (4-Vinyl pyridine-co-Methylene bis acrylamide 4-VP:MBAM 90:10).

0.1 g Poly (4-Vinyl pyridine-co-Methylene bis acrylamide) prepared according to example 16, was dissolved in 2 ml water and 10 mg photo initiator 2,2′-azobis (2-amidinopropane) dihydrochloride was added. The solution was exposed to UV irradiation for 15 min. The polymer was crosslinked and formed a gel. This is an indirect evidence for the selective polymerization of one vinyl group in the first stage followed by a second stage polymerization leading to crosslinking. The polymer after crosslinking was found to be insoluble in water, DMF, methanol & DMSO. The polymer obtained shows swelling in water almost 10 times.

The Advantages of the present invention are:
1. A simple and easy method of preparation of solvent soluble copolymers having multiple unsaturations.
2. Provides unsaturated site for further modifications.
3. The unreacted crosslinker can be removed easily in the first step before crosslinking.
4. Provides versatility of reaction medium i.e. organic solvents as well as aqueous medium can be used to carry out polymerization.
5. Water-soluble as well as oil soluble initiators can be used for initiation.

1. Soluble polymers of vinyl monomers having a general formula [A₍ₓ₎B_{(y)}]ₙ wherein ‘A’ is based on any vinyl monomer comprising one unsaturation, ‘B’ is based on a monomer containing multiple unsaturations and x=1 to 15, y=1 to 15 and n=10 to 1000.

2. A polymer composition of the polymers as claimed in claim 1, wherein the content of the monomer with multiple unsaturations is varied from 0.01 to 99.9%.

3. Polymers as claimed in claim 1, are soluble in organic solvents and water and contain pendent vinyl unsaturations.

4. A polymer as claimed in claim 1, wherein the vinyl monomers comprising one unsaturation are hydrophobic or hydrophilic.

5. A polymer as claimed in claim 1, wherein the vinyl monomers comprising one unsaturation are hydrophilic and acidic, basic or neutral.

6. A polymer as claimed in claim 1, wherein the vinyl monomers comprising one unsaturation are hydrophilic and acidic are acrylic acid, methacrylic acid, and 2-acrylamido 2-methyl propane sulphonic acid.

7. A polymer as claimed in claim 1, wherein the preferred hydrophilic and acidic vinyl monomer comprising one unsaturation is acrylic acid.

8. A polymer as claimed in claim 1, wherein the vinyl monomers comprising one unsaturation are hydrophilic and basic are 2-Dimethyl amino ethyl methacrylate, 2-Diethyl amino ethyl methacrylate, 4-Vinyl pyridine, 2-Dimethyl amino ethyl acrylate, 2-Diethyl amino ethyl acrylate.

9. A polymer as claimed in claim 1, wherein the preferred hydrophilic and basic vinyl monomer comprising one unsaturation are 2-Dimethyl amino ethyl methacrylate, 4-Vinyl pyridine.

10. A polymer as claimed in claim 1, wherein the vinyl monomers comprising one unsaturation are hydrophilic and neutral are 2-hydroxyethyl methacrylate, acrylamide, N-vinyl pyrrolidone, N-2 hydroxypropyl methacrylamide, N-3 hydroxypropyl methacrylamide, N,N′ dimethyl acrylamide.

11. A polymer as claimed in claim 1, wherein the preferred hydrophilic and neutral vinyl monomers comprising one unsaturation are 2-hydroxyethyl methacrylate, acrylamide, N-vinyl pyrrolidone, N-2 hydroxypropyl methacrylamide, N-3 hydroxypropyl methacrylamide.

12. A polymer as claimed in claim 1, wherein the monomers containing multiple unsaturations are Methylene bis acrylamide/Methylene bis methacrylamide, Ethylene bis acrylamide/Ethylene bis methacrylamide, Propylene bis acrylamide/Propylene bis methacrylamide, Butylene bis acrylamide/Butylene bis methacrylamide, Phenylene bis acrylamide/Phenylene bis methacrylamide, Tris (2-methacrylamido ethyl)amine/Tris (2-acrylamido ethyl)amine, 2,4,6-Trimethacrylamido-1,3,5-triazine/2,4,6-Tri acrylamido-1,3,5-triazine, N,N′-(4,7,10-tri oxa tridecamethylene)-bis acrylamide/N,N′-(4,7,10-tri oxa tridecamethylene)-bis methacrylamide, N,N′-(4,9-dioxa dodecamethylene)-bis acrylamide/N,N′-(4,9-dioxa dodecamethylene)-bis methacrylamide, 2,4,5,6 tetra-methacrylamido pyrimidine sulfate/2,4,5,6 tetra-acrylamido pyrimidine sulfate, 4,5,6 tris acrylamido pyrimidine sulfate/4,5,6 tris acrylamido pyrimidine sulfate.

13. A polymer as claimed in claim 1, wherein the preferred monomers containing multiple unsaturations are Methylene bis acrylamide and Ethylene bis methacrylamide.

14. A process for the preparation of soluble copolymers as claimed in claim 1, which comprises dissolving an inclusion complex of a monomer containing multiple unsaturations with a cyclic macromolecular compound having a mole ratio of monomer to cyclic compound in the range of 1:1 to 1:2 in an appropriate solvent, adding at least one vinyl monomer and a free radical initiator to this solution and polymerizing by conventional methods to obtain the product.

15. A process for the preparation of polymers as claimed in claim 14, wherein the inclusion complexes are prepared as per the process claimed and described in co-pending application 281NF2004.

16. A process for the preparation of polymers as claimed in claim 14, wherein the monomer containing multiple unsaturations is an aliphatic, aromatic or heterocyclic compound.

17. A process for the preparation of polymers as claimed in claim 14, wherein the monomer containing multiple unsaturations is selected from the group of bis acrylamides/methacrylamides.

18. A process for the preparation of polymers as claimed in claim 14, wherein the monomer containing multiple unsaturations are Methylene bis acrylamide/Methylene bis methacrylamide, Ethylene bis acrylamide/Ethylene bis methacrylamide, Propylene bis acrylamide/Propylene bis methacrylamide, Butylene bis acrylamide/Butylene bis methacrylamide, Phenylene bis acrylamide/Phenylene bis methacrylamide, Tris (2-methacrylamido ethyl)amine/Tris (2-acrylamido ethyl)amine, 2,4,6-Trimethacrylamido-1,3,5-triazine/2,4,6-Th acrylamido-1,3,5-triazine, N,N′-(4,7,10-tri oxa tridecamethylene)-bis acrylamide/N,N′-(4,7,10-tri oxa tridecamethylene)-bis methacrylamide, N,N′-(4,9-dioxa dodecamethylene)-bis acrylamide/N,N′-(4,9-dioxa dodecamethylene)-bis methacrylamide, 2,4,5,6 tetra-methacrylamido pyrimidine sulfate/2,4,5,6 tetra-acrylamido pyrimidine sulfate, 4,5,6 tris acrylamido pyrimidine sulfate/4,5,6 tris acrylamido pyrimidine sulfate.

19. A process for the preparation of polymers as claimed in claim 14, wherein the preferred monomers containing multiple unsaturations are Methylene bis acrylamide and Ethylene bis methacrylamide in the form of inclusion complexes.

20. A process for the preparation of polymers as claimed in claim 14, wherein the vinyl monomers comprising one unsaturation are hydrophobic or hydrophilic.

21. A process for the preparation of polymers as claimed in claim 14, wherein the vinyl monomers comprising one unsaturation are hydrophilic and acidic, basic or neutral.

22. A process for the preparation of polymers as claimed in claim 14, wherein the vinyl monomers comprising one unsaturation are hydrophilic and acidic are acrylic acid, methacrylic acid, and 2-acrylamido 2-methyl propane sulphonic acid.

23. A process for the preparation of polymers as claimed in claim 14, wherein the preferred hydrophilic and acidic vinyl monomer comprising one unsaturation is acrylic acid.

24. A process for the preparation of polymers as claimed in claim 14, wherein the vinyl monomers comprising one unsaturation are hydrophilic and basic are 2-Dimethyl amino ethyl methacrylate, 2-Diethyl amino ethyl methacrylate, 4-Vinyl pyridine, 2-Dimethyl amino ethyl acrylate, 2-Diethyl amino ethyl acrylate.

25. A process for the preparation of polymers as claimed in claim 14, wherein the preferred hydrophilic and basic vinyl monomer comprising one unsaturation are 2-Dimethyl amino ethyl methacrylate, 4-Vinyl pyridine.

26. A process for the preparation of polymers as claimed in claim 14, wherein the vinyl monomers comprising one unsaturation are hydrophilic and neutral are 2-hydroxyethyl methacrylate, acrylamide, N-vinyl pyrrolidone, N-2 hydroxypropyl methacrylamide, N-3 hydroxypropyl methacrylamide, N,N′ dimethyl acrylamide.

27. A process for the preparation of polymers as claimed in claim 14, wherein the preferred hydrophilic and neutral vinyl monomers comprising one unsaturation are 2-hydroxyethyl methacrylate, acrylamide, N-vinyl pyrrolidone, N-2 hydroxypropyl methacrylamide, N-3 hydroxypropyl methacrylamide.

28. A process for the preparation of polymers as claimed in claim 14, wherein the organic solvents used for polymerization are N,N′ dimethyl formamide or N,N′ dimethyl sulphoxide, N,N′ dimethyl acetamide.

29. A process for the preparation of polymers as claimed in claim 14, wherein the preferred organic solvent used for polymerization is N,N′ dimethyl formamide.

30. A process for the preparation of polymers as claimed in claim 14, wherein the solvent used for polymerization is water.

31. A process for the preparation of polymers as claimed in claim 14, wherein the initiators used for polymerization are thermal, redox or photoinitiator.

32. A process for the preparation of polymers as claimed in claim 14, wherein the thermal initiators used are either oil or water soluble.

33. A process for the preparation of polymers as claimed in claim 14, wherein the oil soluble thermal initiators used for polymerization are azo bis isobutyronitrile, benzoyl peroxide, t-butyl peroxide, cumyl peroxide, 1,1′ azobis (cyclohexane carbonitrile).

34. A process for the preparation of polymers as claimed in claim 14, wherein the preferred oil soluble thermal initiator is azo bis isobutyronitrile.

35. A process for the preparation of polymers as claimed in claim 14, wherein the water soluble thermal initiators used for polymerization are 2,2′azo bis amidino propane dihydrochloride, potassium persulphate, ammonium persulphate, azo bis cyano valeric acid.

36. A process for the preparation of polymers as claimed in claim 14, wherein the preferred water soluble thermal initiator is 2,2′ azo bis amidino propane dihydrochloride and potassium persulphate.

37. A process for the preparation of polymers as claimed in claim 14, wherein the redox initiator is sodium metabisulphite-potassium persulphate, sodium sulphite-potassium persulphate.

38. A process for the preparation of polymers as claimed in claim 14, wherein the preferred redox initiator is sodium metabisulphite-potassium persulphate.

39. A process for the preparation of polymers as claimed in claim 14, wherein the photoinitiator used for the polymerization is oil or water soluble.

40. A process for the preparation of polymers as claimed in claim 14, wherein the water soluble photoinitiators are 2,2′ azo bis(2-amidino propane) dihydrochloride, azo bis cyanovaleric acid.

41. A process for the preparation of polymers as claimed in claim 14, wherein the preferred water soluble photoinitiator is 2,2′ azo bis(2-amidino propane) dihydrochloride.

42. A process for the preparation of polymers as claimed in claim 14, wherein the oil soluble photoinitiators are 2-hydroxy cyclohexyl phenyl ketone, 2,2′-azobis (2,4-dimethyl valeronitrile), 2,2′-azobis (2-methyl butyronitrile).

43. A process for the preparation of polymers as claimed in claim 14, wherein the preferred oil soluble photoinitiator is 2-hydroxy cyclohexyl phenyl ketone.

44. A process for the preparation of polymers as claimed in claim 14, wherein the temperature for the polymerization is from 20° C. to 65° C.

45. Crosslinked polymers obtained by the crosslinking of polymers as described in claim 1 by free radical polymerization method.

46. Crosslinked polymers of vinyl monomers having a general formula [A₍ₓ₎B_{(y)}]n wherein ‘A’ is based on any vinyl monomer comprising one unsaturation, ‘B’ is based on a monomer containing multiple unsaturations and x=1 to 15, y=1 to 15 and n=10 to 1000.

47. A crosslinked polymer as claimed in claim 46, wherein the content of the monomer with multiple unsaturations is varied from 0.01 to 99.9%.

48. A process for the preparation of crosslinked polymers as claimed in claim 46 from the soluble copolymers, comprises dissolving copolymer in an appropriate solvent, adding a free radical initiator to this solution and crosslinking by conventional methods to obtain the insoluble product.

49. A process as claimed in claim 48, wherein the solvent for crosslinking is organic.

50. A process as claimed in claim 48, wherein the organic solvents used for crosslinking are N,N′ dimethyl formamide, N,N′ dimethyl sulphoxide, N,N′ dimethyl acetamide.

51. A process as claimed in claim 48, wherein the preferred organic solvent used for crosslinking is N,N′ dimethyl formamide.

52. A process as claimed in claim 48, wherein the solvent used for crosslinking is water.

53. A process as claimed in claim 48, for the preparation of crosslinked polymers wherein the initiation is either thermal, redox or by photopolymerization.

54. A process for the preparation of crosslinked polymers as claimed in claim 48 wherein the thermal initiators used for crosslinking are water soluble or oil soluble.

55. A process for the preparation of crosslinked polymers as claimed in claim 48 wherein water soluble thermal initiators are potassium persulphate, ammonium persulphate, 2,2′ azo bis(2-amidino propane) dihydrochloride, azo bis cyano valeric acid.

56. A process for the preparation of crosslinked polymers as claimed in claim 48 wherein preferred water soluble thermal initiators are potassium persulphate and 2,2′ azo bis(2-amidino propane) dihydrochloride.

57. A process for the preparation of crosslinked polymers as claimed in claim 48 wherein oil soluble thermal initiators are azo bis isobutyronitrile, benzoyl peroxide, t-butyl peroxide and cumyl peroxide.

58. A process for the preparation of crosslinked polymers as claimed in claim 48 wherein the preferred oil soluble thermal initiator is azo bis isobutyronitrile.

59. A process for the preparation of crosslinked polymers as claimed in claim 48 wherein the photoinitiator used for the polymerization are either water soluble or oil soluble.

60. A process for the preparation of crosslinked polymers as claimed in claim 48 wherein the water soluble photoinitiators are 2,2′ azo bis(2-amidino propane) dihydrochloride, azo bis cyanovaleric acid.

61. A process for the preparation of crosslinked polymers as claimed in claim 48 wherein the preferred water soluble photoinitiator is 2,2′ azo bis(2-amidino propane) dihydrochloride.

62. A process for the preparation of crosslinked polymers as claimed in claim 48 wherein the oil soluble photoinitiators are 2-hydroxy cyclohexyl phenyl ketone, 2,2′-azobis (2,4-dimethyl valeronitrile), 2,2′-azobis (2-methyl butyronitrile).

63. A process for the preparation of crosslinked polymers as claimed in claim 48 wherein the preferred oil soluble photoinitiator is 2-hydroxy cyclohexyl phenyl ketone.

64. A process for the preparation of crosslinked polymers as claimed in claim 48 wherein the temperature for the polymerization is from 20° C. to 65° C.

65. (canceled)
